(19) United States
(12) Patent Application Publication
(10) Pub. No.: US 2006/0159983 A1
(43) Pub. Date: Jul. 20, 2006

(54) Fuel electrode for solid oxide fuel cell and solid oxide fuel cell suing the same

(75) Inventor: Dong Song, KANAGAWA-KEN (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 10/547,135

(22) PCT Filed: Apr. 5, 2004
(86) PCT No.: PCT/JP04/04915

§ 371 Date: Aug. 26, 2005

(30) Foreign Application Priority Data
Apr. 30, 2003 (JP) 2003-125131

(51) Int. Cl. H01M 4/86; H01M 8/12; H01B 1/02

(52) U.S. Cl. 429/44; 429/30; 252/512

(57) ABSTRACT

A fuel electrode for solid oxide fuel cell of the present invention comprises a cermet containing an oxide phase having oxygen ion conductivity and a metal phase, Further, the fuel electrode constitutes a three-dimensional network structure, and the oxide phase forms a skeleton of the network structure, and has pores in the vicinity of the metal phase. Thereby, the three phase zone of the fuel electrode can be increased in order to improve the output of SOFC.

### TECHNICAL FIELD

The present invention relates to a fuel electrode for solid oxide fuel cell (SOFC) and SOFC using the same. In particular, the present invention relates to a fuel electrode for SOFC, which can increase a three phase zone as a reaction site of the fuel electrode, raise the porosity of the fuel electrode, and improve output at the time of electricity generation in SOFC, and to SOFC using the same.

### BACKGROUND ART

Conventionally, it has been proposed that a fuel electrode is constructed in the following manner to prevent interfacial exfoliation due to sintering of nickel particles and a difference in thermal expansion from an electrolyte (refer to Japanese Patent Application Laid-Open No. H6-89723). In a method of forming a fuel electrode in a related art, an aqueous metal salt solution of metal acting as a fuel electrode is first prepared, and a porous material powder is then immersed therein. Then, this powder is heat-treated to support the metal on the surface of the porous material. The metal-supporting powder is molded and baked to prepare a fuel electrode.

It is also proposed in a related art that a solution of a starting material is powdered by spray pyrolysis in order to obtain electrode-forming spherical particles having a larger contact site among the particles than that of amorphous secondary electrode particles (refer to Japanese Patent Application Laid-open No. H7-267613).

### DISCLOSURE OF THE INVENTION

However, the aggregation of metal particles such as nickel, which occurs in high-temperature baking, cannot be sufficiently prevented in the related art. In the related art, however, the number of three phase zones formed as the reaction site of the fuel electrode is insufficient to achieve sufficient performance. In the related art, the porosity of the fuel electrode is low, thus improvements in porosity is necessary. By the way, the three phase zone is a site where an electron, an ion, and a gas phase are contacted with one another.

The present invention was made in consideration of the above-described problems, and the object of the present invention is to provide a fuel electrode for SOFC, which can increase the three phase zone of the fuel electrode and raise the porosity to improve the output of SOFC, as well as SOFC using the same.

The first aspect of the present invention provides a fuel electrode for solid oxide fuel cell, comprising: a cermet containing an oxide phase having oxygen ion conductivity and a metal phase, wherein the fuel electrode constitutes a three-dimensional network structure, and the oxide phase forms a skeleton of the network structure, and has pores in the vicinity of the metal phase.

The second aspect of the present invention provides a solid oxide fuel cell, comprising: a fuel electrode for solid oxide fuel cell including a cermet containing an oxide phase having oxygen ion conductivity and a metal phase, wherein the fuel electrode constitutes a three-dimensional network structure, and the oxide phase forms a skeleton of the network structure, and has pores in the vicinity of the metal phase.

### BRIEF DESCRIPTION OF THE DRAWINGS

FIG. 1 is a SEM (scanning electron microscope) view of a fuel electrode for SOFC according to the present invention; and

FIG. 2 is a schematic view illustrating a single cell using the fuel electrode for SOFC according to the present invention.

### BEST MODE FOR CARRYING OUT THE INVENTION

The fuel electrode for SOFC according to the present invention is described in more detail with reference to the drawings.

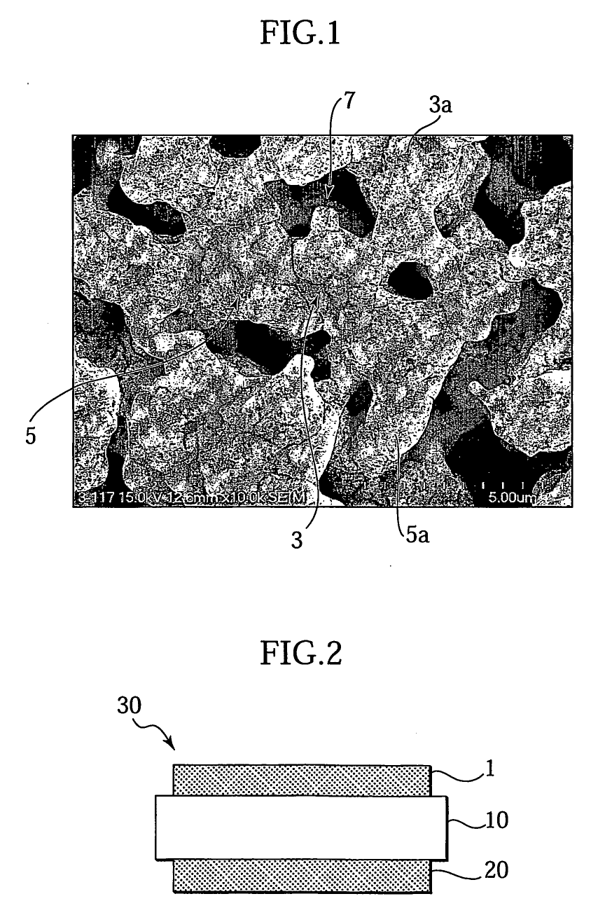

As shown in FIG. 1, the fuel electrode 1 for SOFC according to the present invention contains a cermet including an oxygen ion-conducting oxide phase 3 and a metal phase 5, wherein the fuel electrode 1 forms a three-dimensional network structure, while the oxide phase 3 forms the skeleton of the network structure and has a pore 7 in the vicinity-of the metal phase 5.

It is generally understood that the reaction site of the fuel electrode is a site where three elements, that is, an oxygen ion, an electron, and a hydrogen atom are close to one another. That is, the reaction proceeds in a site called a three phase zone, that is, the interface among three phases consisting of an oxide phase having oxygen ion conductivity, a metal phase having electron conductivity, and a pore (gas phase) diffusing a fuel gas such as hydrogen. As the three phase zone is increased, the reaction area of the fuel electrode is increased to give a larger electric current.

In the case of a usual metal electrode, the reaction site of the electrode is limited to the contact area between the electrode and an electrolyte, while the fuel electrode 1 possesses a cermet structure of the oxide phase 3 and the metal phase 5, thus achieving a larger three phase zone. Further, the whole of the fuel electrode 1 of the present invention has a three-dimensional network structure through which a fuel gas diffuses efficiently into the whole of the fuel electrode 1. The skeleton of the three-dimensional network structure of the fuel electrode 1 is made of the oxide phase 3 so that oxygen ions can diffuse from the contact area between the electrolyte 10 and the fuel electrode 1 through the oxide phase 3 into the fuel electrode in the direction of thickness. That is, the skeleton composed of the oxide phase 3 serves as a path for oxygen ion conduction, to allow oxygen ions to diffuse into the whole of the fuel electrode 1, thus significantly improving the conductivity of oxygen ions in the whole of the fuel electrode 1.

As shown in FIG. 1, the metal phase 5 also occurs over the whole of the fuel electrode 1, thus providing a large number of three phase zones. In the fuel electrode 1, the metal phase 5 occurs continuously on the oxide phase 3 to form an electron-conducting path. Accordingly, the electron conductivity of the fuel electrode is improved to permit electrons to be taken efficiently from the fuel electrode.

The pore 7 also occurs in the vicinity of the metal phase, and thus a fuel gas diffuses through the pore 7 into the whole of the fuel electrode 1 to achieve the efficient reaction between the fuel gas and oxygen ions.

In the fuel electrode 1 for SOFC according to the present invention, the ratio of the metal phase 5 to the oxide phase 3 in the interface of the pore 7 is desirably within a range from 50:50 to 90:10. When the ratio of the oxide phase 3 is higher than 50%, the electrical conductivity and catalytic activity of the fuel electrode 1 may be decreased to exert an adverse effect on the activity of the fuel electrode 1. When the ratio of the oxide phase 3 is less than 10%, it is difficult to suppress the aggregation of metal particles constituting the metal phase 5. The ratio of the metal phase 5 to the oxide phase 3 in the interface of the pore can be regulated by adjusting the amount of the metal constituting the metal phase 5 and the amount of the oxide constituting the oxide phase 3 in forming the fuel electrode 1.

An oxide particle 3a constituting the oxide phase 3 is not particularly limited insofar as it exhibits oxygen ion conductivity, but yttrium stabilized zirconia (YSZ), samarium doped ceria (SDC), samarium and cobalt doped ceria (SCC), yttrium doped ceria (YDC), and strontium and magnesium doped lanthanum gallate (LSGM) can be utilized. The oxide used in the fuel electrode 1 is preferably identical with the oxide used in the electrolyte in SOFC; for example, when YSZ is used in the electrolyte in SOFC, metal and YSZ are used in the fuel electrode 1. Interfacial exfoliation due to a difference in thermal expansion from the electrolyte and generation of heat in the interface due to a difference in oxygen ion conductivity are thereby prevented, thus improving the performance of the fuel electrode.

The particle diameter of the oxide particle 3a constituting the oxide phase 3 is not particularly limited insofar as the fuel electrode 1 has performance such as oxygen ion conductivity, but the average particle diameter of the oxide particle 3a is preferably within a range from 0.1 to 30% of the average length of the oxide phase 3, and specifically the average particle diameter of the oxide particle 3a is preferably within a range from 0.1 to 10 μm. When the particle diameter is less than 0.1 μm, the ion conductivity is decreased, while when the particle diameter is greater than 10 μm, the diffusion distance of oxygen ions is increased, thus giving higher resistance due to diffusion. The “average length of the oxide phase” refers to the average length of the oxide phase 3 formed continuously along the direction of thickness.

A metal particle 5a constituting the metal phase 5 is not particularly limited insofar as it exhibits electrical conductivity and a catalytic activity as necessary, but typically, nickel (Ni), copper (Cu), platinum (Pt), or silver (Ag) and an arbitrary combination of these metals can be used. Even if the metal other than the noble metal is in the form of an oxide except during generation of electricity, the metal during generation of electricity is exposed to a fuel gas, that is, a reducing gas, thus converting the metal oxide easily to the metal by reduction. Accordingly, the fuel electrode 1 wherein an element such as Ni, Cu, or Ag occurs in the form of an oxide falls under the scope of the present invention.

The particle diameter of the metal particle 5a constituting the metal phase 5 is not particularly limited insofar as the fuel electrode 1 exhibits performance such as electrical conductivity and catalytic activity, but the average particle diameter of the metal particle 5a is preferably within a range from 0.1 to 20% of the average length of the metal phase 5, and specifically the average particle diameter of the metal particle 5a is preferably within a range from 1 to 30 μm. When the particle diameter is less than 1 μm, the aggregation of metal particles, particularly nickel particles, proceeds to decrease the catalytic activity. When the particle diameter is greater than 30 μm, the specific surface area of the metal phase is decreased, thus reducing a site for adsorbing the fuel gas. The “average length of the metal phase” refers to the average length of the metal phase formed continuously along the direction of thickness. The shape of the metal particle 5a is not particularly limited insofar as it has the above-described performance, but typically, the metal particle 5a in a spherical, elliptical, and fibrous shape can be mentioned, and metal particles 5a in these two or more shapes can be arbitrarily mixed for use.

The diameter of the pore 7 is preferably within a range from 0.1 to 10 μm. When the diameter is less than 0.1 μm, the fuel gas or a generated gas such as water vapor is prevented from diffusing, while when the diameter is larger than 10 μm, the electrical conductivity of the fuel electrode may be decreased. As the fuel gas, hydrogen, carbon monoxide, and a hydrocarbon such as methane can be used.

An SOFC of the present invention is described below. As shown in FIG. 2, the SOFC 30 of the present invention has the fuel electrode 1 for SOFC according to the present invention. Specifically, the SOFC 30 of the present invention has a structure in which an electrolyte 10 is sandwiched between the fuel electrode 1 of the invention and an air electrode 20. By stacking the SOFC 30 of the present invention, a SOFC in a cylindrical or sheet-shaped form can be produced. The “stacking” includes not only connection of single cells in the direction of thickness, but also connection thereof in a plane direction.

The method of producing the fuel electrode 1 for SOFC according to the present invention is described below. The fuel electrode 1 is obtained by a method of treating metal particles with a salt solution containing elements of oxide particles, that is, by a chemical solution method. As opposed to a conventional method of mechanically mixing powders and the like, the metal or metal oxide can be used regardless of its shape by treatment with a solution of oxide particles dissolved in nitric acid or the like. By using the chemical solution method, the metal or metal oxide can be well dispersed, and if the metal or metal oxide has a smaller particle diameter, it can also be well dispersed. By adjusting the concentration of the salt solution containing elements of oxide particles, the particle diameter of the oxide, particularly a smaller particle diameter, can be easily regulated. Further, the time of mixing metal particles with oxide particles can be reduced.

Specifically, the salt solution containing elements of oxide particles is mixed with metal particles, then stirred and precipitated, whereby the metal particles are contacted with the oxide particles. By baking the mixture, a fuel electrode including metal particles adhering to oxide particles can be formed.

As the chemical solution method, a sol-gel method is desirably used. Metal particles and liquid containing elements of oxide particles are treated by the sol-gel method, whereby the metal particles are well dispersed in the solution containing elements of oxide particles, and simultaneously the metal particles are partially coated with the oxide particles, thus preventing the metal particles from being aggregated upon high-temperature baking.

The metal or metal oxide as the starting material of the metal particles used in the present invention preferably has a specific surface area of at least 3.0 m²/g. Such metal and metal oxide are contacted in a larger area with the oxide particles, leading to an increase in the reaction site in the fuel electrode and preventing aggregation of the metal particles.

Hereinafter, the present invention is described in more detail with reference to the Example and Comparative Example, but the present invention is not limited to these examples.

### EXAMPLE

A mixed solution was prepared by dissolving cerium nitrate hexahydrate (Ce(NO₃)₄.6H₂O) and samarium oxide (Sm₂O₃), 53.5 g in total, in 200 ml nitric acid such that the cerium/samarium ratio became Ce_{0.8}Sm_{0.2}O₂. Further, citric acid and nickel oxide (NiO) were added to this solution, and the solution was converted into sol and gel for 20 hours during which NiO was impregnated therewith, whereby gel was obtained. The average particle diameter of NiO was 1.5 μm, and the specific surface area was 3.5 m²/g. The resulting gel was centrifuged and then dried at 600° C. to give NiO—SDC cermet powder. The resulting NiO—SDC powder was mixed with ethyl cellulose and butyl acetate, and adjusted such that the solids content was 80%, whereby an electrode paste for fuel electrode was obtained. This electrode paste was coated on baked LSGM as an electrolyte by screen printing (baking temperature: 1300° C.) to give a fuel electrode for SOFC in this example. In the fuel electrode in this example, the oxide (oxide phase) and nickel (metal phase) had a cermet structure, the pore diameter was within a range from 2 to 3 μm, and the average particle diameter of the oxide particles was 0.5 μm.

### Comparative Example

A fuel electrode for SOFC in comparative example was obtained by repeating the same procedure as in Example except that the starting powders of NiO and SDC were mechanically milled and mixed to give a complex powder.

The performance was evaluated in the following manner. For evaluation, the fuel electrode in each example was used to construct a cell for evaluation of generation of electricity (electrolyte-supporting cell) as shown in FIG. 2, and used in evaluation of generation of electricity under the following conditions. The air electrode was composed of a samarium strontium cobalt oxide (Sm_{0.5}Sr_{0.5}CoO₂), the solid electrolyte was composed of baked LSGM (diameter, 14 mm; thickness, 0.3 mm), and the fuel electrode was composed of the above-described NiO—SDC.

The evaluation conditions were as follows: The cell temperature was 600° C., and the fuel gas composition was 95% by volume H₂ and 5% by volume H₂O.

As a result of the evaluation, the output of the cell in Example was 100 mW/cm², and the output of the cell in Comparative Example was 60 mW/cm². As can be seen from these results, the output of the cell in Example falling under the scope of the present invention is higher than that in Comparative Example beyond the present invention.

The entire content of a Japanese Patent Application No. P2003-125131 with a filing date of Apr. 30, 2003 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

### INDUSTRIAL APPLICABILITY

As described above, the fuel electrode for SOFC according to the present invention contains a cermet including an oxide phase having oxygen ion conductivity and a metal phase, wherein the fuel electrode constitutes a three-dimensional network structure, and the oxide phase forms the skeleton of the network structure, and has pores in the vicinity of the metal phase. Accordingly, the fuel electrode of the present invention has many three phase zones as the reaction site, and as a result, a larger electric current can be taken. By using the fuel electrode of the present invention in SOFC, SOFC with improved output can be obtained.

1. A fuel electrode for solid oxide fuel cell, comprising:
a cermet containing an oxide phase having oxygen ion conductivity and a metal phase,
wherein the fuel electrode constitutes a three-dimensional network structure, and the oxide phase forms a skeleton of the network structure, and has pores in the vicinity of the metal phase.

2. The fuel electrode for solid oxide fuel cell of claim 1,
wherein the skeleton is an oxygen ion-conducting path.

3. The fuel electrode for solid oxide fuel cell of claim 1,
wherein a ratio of the metal phase to the oxide phase in the interface of the pore is within a range from 50:50 to 90:10.

4. The fuel electrode for solid oxide fuel cell of claim 1,
wherein an average particle diameter of metal particles constituting the metal phase is within a range from 0.1 to 20% of an average length of the metal phase.

5. The fuel electrode for solid oxide fuel cell of claim 1,
wherein an average particle diameter of metal particles constituting the metal phase is within a range from 1 to 30 μm.

6. The fuel electrode for solid oxide fuel cell of claim 1,
wherein an average particle diameter of oxide particles constituting the oxide phase is within a range from 0.1 to 30% of an average length of the oxide phase.

7. The fuel electrode for solid oxide fuel cell of claim 1,
wherein an average particle diameter of oxide particles constituting the oxide phase is within a range from 0.1 to 10 μm.

8. The fuel electrode for solid oxide fuel cell of claim 1,
wherein a diameter of the pore is within a range from 0.1 to 10 μm.

9. The fuel electrode for solid oxide fuel cell of claim 1,
wherein a shape of metal particles constituting the metal phase is at least one shape selected from the group consisting of a spherical shape, an elliptical shape, and a fibrous shape.

10. The fuel electrode for solid oxide fuel cell of claim 1,
wherein metal particles constituting the metal phase are constituted by at least one element selected from the group consisting of nickel, copper, platinum, and silver.

11. The fuel electrode for solid oxide fuel cell of claim 1,
wherein the fuel electrode is prepared by a chemical solution method of treating metal particles constituting the metal phase with a salt solution of oxide particles constituting the oxide phase.

12. The fuel electrode for solid oxide fuel cell of claim 11,
wherein the chemical solution method is a sol-gel method.

13. The fuel electrode for solid oxide fuel cell of claim 11,
wherein metal or metal oxide having a specific surface area of at least 3.0 m²/g is used as a starting material of the metal particles.

14. A solid oxide fuel cell, comprising:
a fuel electrode for solid oxide fuel cell including a cermet containing an oxide phase having oxygen ion conductivity and a metal phase,
wherein the fuel electrode constitutes a three-dimensional network structure, and the oxide phase forms a skeleton of the network structure, and has pores in the vicinity of the metal phase.
